(19) United States
(12) Patent Application Publication
(10) Pub. No.: US 2024/0227264 A9
(43) Pub. Date: Jul. 11, 2024

(54) INSULATION SYSTEM FOR INJECTION MOLDING HOT RUNNER

(71) Applicant: SINGH VISION SYSTEMS LLC, Portage, MI (US)

(72) Inventor: Charles Vernon Rupert, II, Rochester Hills, MI (US)

(21) Appl. No.: 18/547,383

(22) PCT Filed: Feb. 23, 2022
(86) PCT No.: PCT/US2022/017423

§ 371 Date: Aug. 22, 2023

Related U.S. Application Data
(60) Provisional application No. 63/152,570, filed on Feb. 23, 2021.

(51) Int. Cl. B29C 45/27; B29C 45/03; B29C 45/73

(52) U.S. Cl. CPC B29C 45/2737; B29C 45/03; B29C 45/73; B29C 2045/2766; B29K 2905/00; B29K 2913/00

(57) ABSTRACT

An insulation system includes a panel that is configured to fit with a hot runner of an injection molding machine. The panel has panel walls that define a closed interior cavity. There is an insulation material disposed in the closed interior region. The panel has a panel geometry that is complementary to the geometry of the hot runner such that the panel fits intimately with the hot runner.

### BACKGROUND

Injection molding is a common process for manufacturing plastic components. It involves the injection of molten plastic into a cavity of a mold. The cavity is shaped like the component. The mold is cooled such that the plastic solidifies in the cavity with the shape of the component. After a holding period to ensure that the plastic is fully solidified (typically to a temperature below the glass transition temperature of the plastic), the mold is then opened and the component is ejected from the cavity.

A runner is a passage, or system of passages, that is/are used to deliver the molten plastic into the cavity. One type of runner is known as a cold runner. Cold runners are at a temperature below the melting point of the plastic. The plastic solidifies in the runners and is removed with the component. Since the solidified runners are not intended to be part of the final component, they are removed from the component and scraped or recycled. In contrast, hot runners are heated at a temperature above the molting point of the plastic so that the molten plastic does not solidify in the runners. Hot runners thereby reduce waste because there is no solidified runner to scrap or recycle. Moreover, the holding period for a hot runner system may be reduced because no time is needed to wait for the plastic in the runner to solidify as in a cold runner.

Since hot runners are heated and the mold cavity is cooled, a insulating air gap is used around the hot runners for thermal isolation. The air gap also permits control over the temperature of the hot runner. In practice, however, the temperature across the hot runners varies and there inevitably are “hot” and “cold” regions of the runners. These hot and cold regions dictate how the temperature of the hot runners is controlled relative to the melting point of the plastic. For instance, the heating of the hot runners must compensate for the temperature at the coldest “cold” region so that the temperature at that location is higher than the melting point of the plastic, otherwise the plastic will undesirably solidify in that cooler portion of the runner. Higher temperatures, however, generally lengthen cycle time because more heat must then be removed during solidification, which decreases process efficiency. If overheated, portions of the molten plastic may thermally degrade and debit component quality. Accordingly, the ability to control the temperature of the hot runners has a significant impact on the molding process. Unfortunately, there have been substantial challenges in controlling the temperature, thus resulting in persistently long cycle times, small processing windows and, in some cases, sacrifices in component quality.

### SUMMARY

An insulation system according to an example of the present disclosure includes a panel that is configured to fit with a hot runner. The panel has panel walls that define at least one closed interior cavity, and an insulation material disposed in the at least one closed interior region.

In a further embodiment of any of the foregoing embodiments, the insulation material is granular.

In a further embodiment of any of the foregoing embodiments, the insulation material has a composition that includes amorphous fumed silica.

In a further embodiment of any of the foregoing embodiments, the composition includes silicon carbide.

In a further embodiment of any of the foregoing embodiments, the insulation material has a composition that includes amorphous fumed silica, and the composition has, by weight, 50% to 70% of the amorphous fumed silica.

In a further embodiment of any of the foregoing embodiments, the composition includes silicon carbide, and the composition has, by weight, 50% to 30% of the silicon carbide.

In a further embodiment of any of the foregoing embodiments, the panel walls are stainless steel or fabric.

In a further embodiment of any of the foregoing embodiments, the panel walls define perimeter sides and opposed first and second face sides that define a thickness direction there between. The panel has at least one through-hole from the first face side to the second face side.

In a further embodiment of any of the foregoing embodiments, the panel is cylindrical.

In a further embodiment of any of the foregoing embodiments, the panel walls are fabric and are stitched together such that there are a plurality of the closed interior cavities.

In a further embodiment of any of the foregoing embodiments, the panel is flexible.

An insulation system according to an example of the present disclosure includes an injection molding machine that includes a heating module, a mold that defines a mold cavity, and a hot runner that connects the heating module to the mold cavity. The hot runner has a hot runner geometry, and there is a panel adjacent the hot runner. The panel has panel walls that define at least one closed interior cavity and a panel geometry that is complementary to the hot runner geometry such that the panel fits intimately with the hot runner. There is an insulation material is disposed in the at least one closed interior region.

In a further embodiment of any of the foregoing embodiments, the hot runner geometry has protrusions, and the panel geometry has though-holes that align with the protrusions such that the protrusions extend into the through-holes.

In a further embodiment of any of the foregoing embodiments, the insulation material has a composition that includes amorphous fumed silica and silicon carbide.

In a further embodiment of any of the foregoing embodiments, the insulation material is granular.

In a further embodiment of any of the foregoing embodiments, the insulation material has a composition that includes amorphous fumed silica and silicon carbide, and the composition has, by weight, 35% to 70% of the amorphous fumed silica and 50% to 30% of the silicon carbide.

In a further embodiment of any of the foregoing embodiments, the panel walls are stainless steel or fabric.

In a further embodiment of any of the foregoing embodiments, the panel walls are fabric and are stitched together such that there are a plurality of the closed interior cavities.

A method according to an example of the present disclosure includes providing a mold that defines a mold cavity and a hot runner that connects to the mold cavity. The hot runner has a hot runner geometry. There is a panel that has panel walls that define a closed interior cavity and a panel geometry that is complementary to the hot runner geometry. There is an insulation material disposed in the closed interior region. The panel is installed on the hot runner by mating the panel geometry to the hot runner geometry so that the panel fits intimately with the hot runner.

In a further embodiment of any of the foregoing embodiments, the hot runner geometry has protrusions the panel geometry has though-holes, and the installing includes aligning the through-holes with the protrusions and moving the panel such that the protrusions extend into the through-holes.

The present disclosure may include any one or more of the individual features disclosed above and/or below alone or in any combination thereof.

### BRIEF DESCRIPTION OF THE DRAWINGS

The various features and advantages of the present disclosure will become apparent to those skilled in the art from the following detailed description. The drawings that accompany the detailed description can be briefly described as follows. In this disclosure, like reference numerals designate like elements where appropriate and reference numerals with the addition of one-hundred or multiples thereof designate modified elements that are understood to incorporate the same features and benefits of the corresponding elements.

FIG. 1 illustrates an example of an insulation system.

FIG. 2 illustrates an example of a panel for insulating a hot runner.

FIG. 3 illustrates a sectioned view of the panel.

FIG. 4 illustrates installation of a panel onto a hot runner.

FIG. 5 illustrates another example of a panel that is made of quilted fabric.

FIG. 6 illustrates another example of a panel that is cylindrical.

### DETAILED DESCRIPTION

As discussed above, the ability to control the temperature of hot runners has a significant impact on a molding process. An air gap provides limited effectiveness. Application of insulating materials, such as fiberglass and asbestos, is limited. For instance, fiberglass provides an uneven insulating effect and breaks down over extended thermal cycling. Asbestos is more durable than fiberglass for thermal cycling but may create handling concerns. Thus, there have been substantial challenges in providing a more uniform insulating effect that is durable and that can be readily handled for easy installation. In these regards, disclosed herein and described below is an insulation system for facilitating injection molding efficiency, durability, and handling improvements.

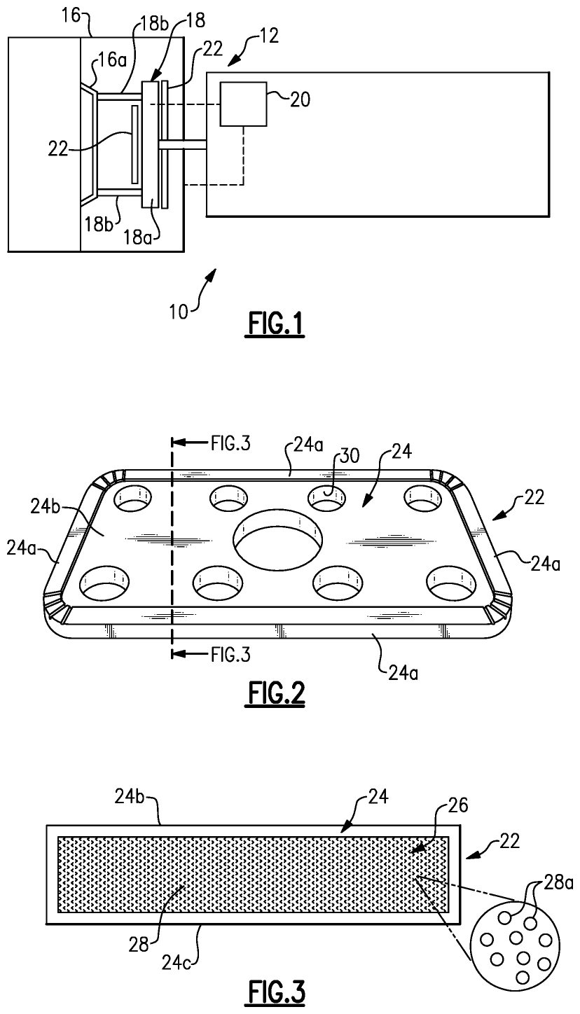

FIG. 1 schematically illustrates various aspects of an example of an insulation system 10. The system 10 includes an injection molding machine 12 that is comprised of a heating module 14, a mold 16 that defines a mold cavity 16a therein, and a hot runner 18 that connects the heating module 14 to the mold cavity 16a.

The heating module 14 is not particularly limited but most typically will include an injection unit that has a heated barrel that houses a reciprocating screw. Raw material in the form of plastic pellets is fed through a hopper into the heated barrel. The reciprocating screw serves to mix, compress, and meter the molten plastic into the hot runner 18. A controller 20 is operably connected with the heating module 14, mold 16, and hot runner 18. The controller 20 may include hardware (e.g., memory, microprocessor, display, etc.), software, or both that is programmable to control the operation of the heating module 14 (screw rotation, reciprocation, heating, etc.), the mold 16 (opening, closing, clamp pressure, etc.), and the hot runner 18 (heating).

The hot runner 18 connects the heating module 14 to the mold cavity 16a. As used herein, the term “hot runner” refers to a passage or system or passages that has/have heaters in order to keep the plastic in a molten state. As shown, the hot runner 18 includes a manifold section 18a and one or more “drops” 18b (two shown) that connect the manifold section 18a to the mold cavity 16a. The manifold section 18a and drops 18b include heaters (not shown), such as coil resistance heaters.

The system 10 further includes one or more panels 22 located adjacent to the hot runner 18. For instance, as shown, the panels 22 are located adjacent the manifold section 18a of the hot runner 18, although they may alternatively or additional be located adjacent the drops 18b. Each panel 22 serves to thermally insulate the hot runner 18 and thereby facilitate temperature control of the hot runner 18. In this regard, each panel 22 is configured to fit intimately with the hot runner 18 in order to enhance the insulating effects. As used in this disclosure, the system 10 may refer collectively to the injection molding machine 12 and panel 22, or to the panel 22 alone.

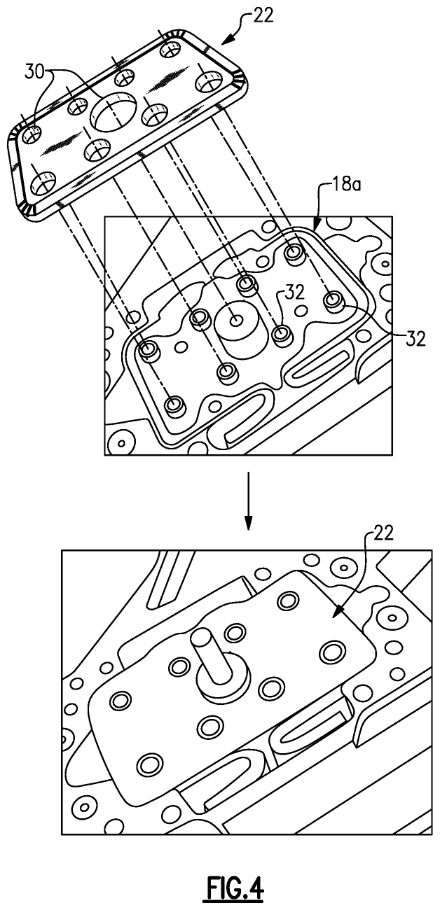

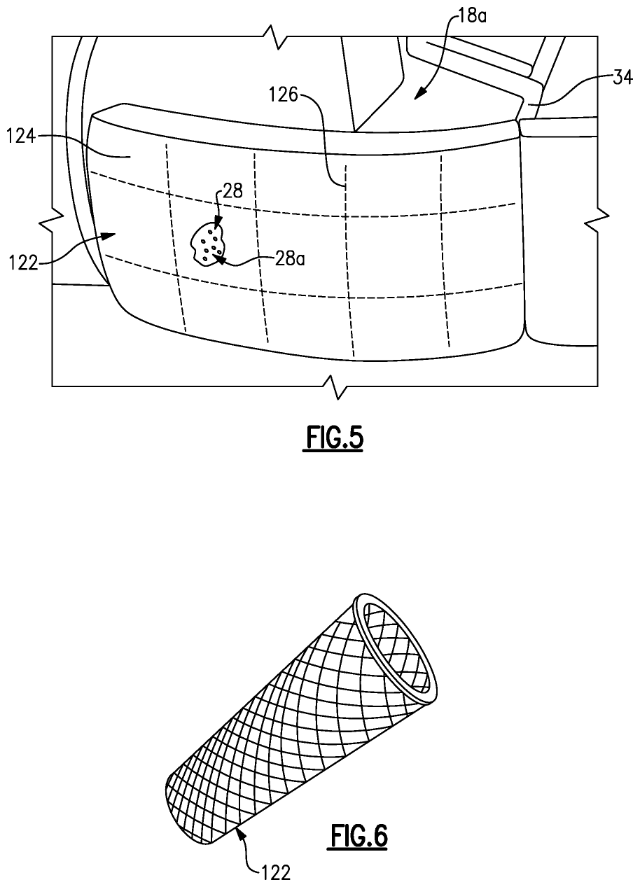

FIG. 2 illustrates an isolated view of a representative example of one of the panels 22, and FIG. 3 illustrates a sectioned view of the panel 22. As will be appreciated, the shape of the panel 22 shown has been designed to complement the shape of the hot runner 18 onto which it fits, and this shape will thus vary between hot runners of different shapes. In general, however, each such panel 22 includes panel walls 24 that define at least one closed interior cavity 26 and insulation material 28 disposed in the closed interior cavity 26.

The panel walls 24 permit the durability, performance, and shape of the panel 22 to be tailored to the hot runner 18 and molding process. For example, the panel walls 24 are made of a material that will withstand the expected temperatures to which the panel 22 is to be exposed. In one example, the panel walls 24 are stainless steel in order to provide good high-temperature resistance and long term resistance to corrosion. The panel 22 also permits wider choice of insulation material 28, especially materials which would otherwise be challenging to use because of their form. For example, since the panel walls 24 contain the insulation material 28 in the closed interior cavity 26, granulated materials, fabrics, and like materials that do not readily hold shape on their own can be used.

In the example shown in FIG. 3, the insulation material 28 is granular (granules 28a). The granules 28a have a composition that includes amorphous fumed silica. For instance, the composition has, by weight, 30% to 70% of the amorphous fumed silica. In a further example, the composition also includes silicon carbide. For instance, the composition has, by weight, 70% to 30% of the silicon carbide. In a further example, the insulation material 28 has a thermal conductivity under ASTM C518 of 0.29 W/m·C.° at 149 C.° and 0.032 W/m·C.° at 260 C.°.

As indicated above, the panel 22 is configured to fit intimately with the hot runner 18. In the illustrated example, the panel walls 24 are rigid and have sides 24a that define a closed perimeter and opposed first and second face sides 24b/24c that define a thickness direction there between. The panel 22 has at least one through-hole 30 from the first face side 24b to the second face side 24c. The through-holes 30 may be of the same size or different sizes, depending on the design of the hot runner 18. The size of the panel 22, the perimeter shape of the panel 22, the thickness of the panel 22, the presence of the through-holes 30, the size of the through-holes 30, and the location of the through-holes 30 together define a panel geometry.

A portion of the manifold section 18a of the hot runner 18 is shown in FIG. 4. In this example, the manifold section 18a has protrusions 32. For example, a protrusion 32 may be a fastener head, an inlet fitting, bushing, or other feature that projects from the main body of the manifold section 18a. The collective profile of the protrusions 32 defines a hot runner geometry. The panel geometry is complementary to the hot runner geometry in that, when installed, the protrusions 32 extend into the through-holes 30, enabling the panel 22 to fit intimately with the hot runner 18.

FIG. 4 also represents a method of assembling the panel 22 on the hot runner 18. In this regard, the assembly may be conducted as part of an original equipment manufacture of the injection molding machine 12, mold 16, or hot runner 18, as a retrofit to a pre-existing injection molding machine 12, mold 16, or hot runner 18, or as part of a repair and/or maintenance procedure. In any case, the panel 22 will be designed with a panel geometry that is complementary to the geometry of the hot runner 18 and that is of proper size to fit into the available space around the hot runner 18. The panel 22 is installed on the hot runner 18 by mating the panel geometry to the hot runner geometry so that the panel 22 fits intimately with the hot runner 18. For example, an installer aligns the through-holes 30 with the protrusions 32 and then moves the panel 22 such that the protrusions 32 extend into the through-holes 30. If desired, the panel 22 can be secured in place on the hot runner using thermal tape, clips, fasteners, zip-ties, or the like so that the panel 22 maintains an intimate fit with the hot runner 18 and does not shift due to vibration. Further non-limiting aspects of the disclosure are demonstrated in the following examples.

FIG. 6 illustrates another example panel 122 that has panel walls 124 that define a plurality of closed interior cavities 126 and insulation material 28 disposed therein. In this example, the panel walls 124 are made of fabric and are stitched together to form the closed interior cavities 126. The panel 122 may include one layer of stitched fabric or multiple layers stacked together. As an example, the fabric is fire-retardant, either inherently or by treatment, for example. The insulation material 28 (shown in cutaway), such as the granules 28a described above, is held by the panel walls 124 and stitching in the cavities 126. The fabric is flexible and thus the panel 122 is flexible so as to enable the panel 122 to conform to, and bend around, the hot runner 18. For instance, as shown in FIG. 6, the panel 122 curves about the manifold 18a, while also conforming to the surface of the manifold 18a. In this case, the panel 122 is secured in place with a zip-tie 34. The panel 122 can also be shaped to fit the drops 18b. As an example, as shown in FIG. 7, the panel 122 is cylindrical so that it wraps around the aforementioned drop 18b (which is also cylindrical) to substantially maintain contact with the drop 18b around its entire circumference.

### Example 1

Panels in accordance with the examples herein were installed as a retrofit on a hot runner that had two drops of more than 15 inches and two drops of more than 8 inches. The original process assumed a plastic melting point of approximately 400° F., and the temperature of the hot runner was set at 470° F. to compensate for temperature variations in the hot runner. The panels were then installed, and the hot runner temperature was incrementally decreased while the process and molded components were monitored. The molding process was successfully run for an extended time-period at a hot runner temperature of 410° F., resulting in a temperature reduction of 60° F. in comparison to the original process. The molded components ejected from the mold were cool to the touch and had no apparent difference in quality in comparison to components molded by the original process.

### Example 2

An existing injection molding machine had a hot runner that had one drop of greater than 3 inches and another drop of greater than 8 inches. In the original molding process without the panels the hot runner was set at 473° F. to compensate for temperature variations. This hot runner demonstrated a heating time from cold start of 18 minutes to achieve 473° F. Panels in accordance with the examples herein were then installed on the hot runner. With the panels installed, the hot runner demonstrated a heating time from cold start of 10 minutes to achieve 473° F. Similar to Example 1, the hot runner temperature was decreased. The molding process was successfully run for an extended time-period at a hot runner temperature of 410° F., resulting in a temperature reduction of 63° F. in comparison to the original process.

### Example 3

Panels in accordance with the examples herein were installed on a hot runner and the hot runner temperature was lowered similar to Examples 1 and 2. Because of the lower temperature, faster injection times, which induces shear heating, and shorter cooling times could be used to reduce overall cycle time. Cycle time was decreased by over 50%.

The disclosed panel 22 facilitates injection molding efficiency, durability, and handling improvements. Efficiency gains may be made via lower set point temperatures in the hot runner to obtain faster mold cycle times. The panel 22 is formed of panel walls 24 that are heat and corrosion resistant in the end-use environment in order to improve durability. The insulation material 28 is contained inside of the panel 22, thereby protecting the material 28 and enabling facile handling and use of insulation materials that do not readily keep the desired geometries on their own. Furthermore, reduction in cycle times may facilitate lower electrical power usage by the injection molding machine on a cycle basis, thereby lowering the annual carbon footprint by an estimated amount of 10-20%.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. An insulation system, comprising:
a panel configured to fit with a hot runner, the panel having panel walls defining at least one closed interior cavity; and
an insulation material disposed in the at least one closed interior region.

2. The insulation system as recited in claim 1, wherein the insulation material is granular.

3. The insulation system as recited in claim 2, wherein the insulation material has a composition that includes amorphous fumed silica.

4. The insulation system as recited in claim 3, wherein the composition includes silicon carbide.

5. The insulation system as recited in claim 1, wherein the insulation material has a composition that includes amorphous fumed silica, and the composition has, by weight, 30% to 70% of the amorphous fumed silica.

6. The insulation system as recited in claim 5, wherein the composition includes silicon carbide, and the composition has, by weight, 70% to 30% of the silicon carbide.

7. The insulation system as recited in claim 1, wherein the panel walls are stainless steel or fabric.

8. The insulation system as recited in claim 1, wherein the panel walls define perimeter sides and opposed first and second face sides that define a thickness direction there between, the panel having at least one through-hole from the first face side to the second face side.

9. The insulation system as recited in claim 1, wherein the panel is cylindrical.

10. The insulation system as recited in claim 1, wherein the panel walls are fabric and are stitched together such that there are a plurality of the closed interior cavities.

11. The insulation system as recited in claim 1, wherein the panel is flexible.

12. An insulation system, comprising:
an injection molding machine including a heating module, a mold defining a mold cavity, and a hot runner connecting the heating module to the mold cavity, the hot runner having a hot runner geometry;
a panel adjacent the hot runner, the panel having panel walls defining at least one closed interior cavity and a panel geometry that is complementary to the hot runner geometry such that the panel fits intimately with the hot runner; and
an insulation material disposed in the at least one closed interior region.

13. The insulation system as recited in claim 11, wherein the hot runner geometry has protrusions, and the panel geometry has though-holes that align with the protrusions such that the protrusions extend into the through-holes.

14. The insulation system as recited in claim 11, wherein the insulation material has a composition that includes amorphous fumed silica and silicon carbide.

15. The insulation system as recited in claim 14, wherein the insulation material is granular.

16. The insulation system as recited in claim 11, wherein the insulation material has a composition that includes amorphous fumed silica and silicon carbide, and the composition has, by weight, 30% to 70% of the amorphous fumed silica and 70% to 30% of the silicon carbide.

17. The insulation system as recited in claim 11, wherein the panel walls are stainless steel or fabric.

18. The insulation system as recited in claim 11, wherein the panel walls are fabric and are stitched together such that there are a plurality of the closed interior cavities.

19. A method comprising
providing a mold that defines a mold cavity and a hot runner that connects to the mold cavity, wherein the hot runner has a hot runner geometry;
providing a panel that has panel walls that define a closed interior cavity, a panel geometry that is complementary to the hot runner geometry, and an insulation material that is disposed in the closed interior region; and
installing the panel on the hot runner by mating the panel geometry to the hot runner geometry so that the panel fits intimately with the hot runner.

20. The method as recited in claim 19, wherein the hot runner geometry has protrusions the panel geometry has though-holes, and the installing includes aligning the through-holes with the protrusions and moving the panel such that the protrusions extend into the through-holes.
